(19) United States
(12) Patent Application Publication
(10) Pub. No.: US 2025/0153821 A1
(43) Pub. Date: May 15, 2025

(54) CONTROL METHOD APPLIED IN UNDERWATER ROBOT, UNDERWATER ROBOT, AND STORAGE MEDIUM

(71) Applicant: Shenzhen Seauto Technology Co., Ltd., Shenzhen (CN)

(72) Inventor: Zhineng Deng, Shenzhen (CN)

(21) Appl. No.: 19/024,144

(22) Filed: Jan. 16, 2025

Related U.S. Application Data
(63) Continuation-in-part of application No. PCT/CN2023/095583, filed on May 22, 2023.

(30) Foreign Application Priority Data
Apr. 4, 2023 (CN) 202310351100.8

(51) Int. Cl. B63G 8/14; B63B 79/10; B63B 79/40; B63G 8/00; B63G 8/08

(52) U.S. Cl. CPC B63G 8/14; B63B 79/10; B63B 79/40; B63G 8/001; B63G 8/08; B63G 2008/002

(57) ABSTRACT

A control method applied in an underwater robot, an underwater robot, and a storage medium are provided, wherein the control method applied in comprises: determining an attitude angle of the underwater robot according to inspection data of an inertial sensor, and determining a heading angle according to the attitude angle; determining a deviation angle between the heading angle and a target heading angle when there is a deviation between the heading angle and the target heading angle; determining a rotation speed adjustment amount of a travelling motor and/or a water pumping motor according to the deviation angle, and adjusting a rotation speed of the travelling motor and/or the water pumping motor according to the rotation speed adjustment amount. The current heading angle is calculated through the inertial sensor, and the traveling direction of the underwater robot is continuously corrected according to the deviation of the heading angle.

### CROSS-REFERENCE TO RELATED APPLICATIONS

This application is a Bypass Continuation Application of PCT International Application No. PCT/CN2023/095583 filed on May 22, 2023, the entire contents of which are incorporated herein by reference. CONTROLMETHOD APPLIED IN

### TECHNICAL FIELD

The present application pertains to the technical field of robots, and particularly relates to a control method for an underwater robot, an underwater robot, and a storage medium.

### BACKGROUND

A swimming pool cleaning robot is a household consumer robot that clean a swimming pool.

In the process of performing a cleaning task, the swimming pool cleaning robot needs to plan a cleaning route to ensure full coverage cleaning of a specific area of the swimming pool. However, when the swimming pool cleaning robot is operating, the actual moving of the swimming pool cleaning robot may change and deviate from the pre-planned route due to external factors such as an uneven pool bottom and an obstacle that needs to be avoided. Route deviation will stop the swimming pool cleaning robot from completing full coverage cleaning of the specific area of the swimming pool.

The above content is only used to assist in understanding the technical solution of the present application, and does not constitute an admission that the above contents are prior art.

### SUMMARY

### Technical Fields

The present application provides a control method applied in an underwater robot, an underwater robot, and a storage medium, so that the underwater robots may complete full coverage cleaning of a specific area of a swimming pool.

### Technical Characteristics

The present application provides a control method applied in an underwater robot, which includes the following steps:
determining an attitude angle of the underwater robot according to inspection data of an inertial sensor, and determining a heading angle of the underwater robot according to the attitude angle;
determining a deviation angle between the heading angle and a target heading angle of the underwater robot;
determining a rotation speed adjustment amount of a travelling motor and/or a water pumping motor according to the deviation angle, and adjusting a rotation speed of the travelling motor and/or the water pumping motor according to the rotation speed adjustment amount.

Optionally, said determining a rotation speed adjustment amount of a travelling motor and/or a water pumping motor according to the deviation angle and adjusting a rotation speed of the travelling motor and/or the water pumping motor according to the rotation speed adjustment amount further includes:
determining an adjustment amount of an error feedback according to a PID (proportion, integration, differentiation) control algorithm and the deviation angle;
further determining a first rotation speed adjustment amount of the travelling motor and/or the water pumping motor according to the adjustment amount of the error feedback adjustment amount; and
adjusting the rotation speed of the travelling motor and/or the water pumping motor according to the first rotation speed adjustment amount.

Optionally, after adjusting the rotation speed of the travelling motor and/or the water pumping motor according to the first rotation speed adjustment amount further includes:
determining an error angle of the underwater robot;
determining an integral control amount according to the PID control algorithm and the error angle, and determining a second rotation speed adjustment amount of the travelling motor and/or the water pumping motor according to the integral control amount; and
adjusting the rotation speed of the travelling motor and/or the water pumping motor of the underwater robot according to the second rotation speed adjustment amount.

Optionally, after adjusting the rotation speed of the travelling motor and/or the water pumping motor of the underwater robot according to the second rotation speed adjustment amount further including:
obtaining historical change values of the deviation angle;
determining a variation trend of the deviation angle according to the PID control algorithm and the historical change values, and determining a third rotation speed adjustment amount of the travelling motor and/or the water pumping motor according to the variation trend of the deviation angle; and
adjusting the rotation speed of the travelling motor and/or the water pumping motor of the underwater robot according to the third rotation speed adjustment amount.

Optionally, the inertial sensor includes a 3-axis gyroscope and a 3-axis accelerometer, the inspection data of the inertial sensor includes gyroscope parameters and acceleration parameters, and before determining an attitude angle of the underwater robot according to inspection data of an inertial sensor, and determining a heading angle of the underwater robot according to the attitude angle, the control method further including:
obtaining the gyroscope parameters collected by the 3-axis gyroscope and the acceleration parameters collected by the 3-axis accelerometer;
determining an attitude angle of the underwater robot according to inspection data of an inertial sensor and determining a heading angle of the underwater robot according to the attitude angle includes:
converting the acceleration parameters into unit vectors, and applying the vector units and the gyroscope parameters as input parameters to obtain a quaternion array; and
calculating the attitude angle of the underwater robot according to the quaternion array, the attitude angle including a roll angle and a pitch angle.

Optionally, the underwater robot is further equipped with a three-dimensional laser scanner, and before determining an attitude angle of the underwater robot according to inspection data of an inertial sensor and determining a heading angle of the underwater robot according to the attitude angle further includes:
scanning a swimming pool area with a three-dimensional laser scanner, and dividing the swimming pool area into a plurality of areas according to scanning results of the swimming pool area by the three-dimensional laser scanner, each of the plurality of area being equally sized; and
generating a cleaning route planning scheme according to the plurality of areas, and executing the cleaning route planning scheme by the underwater robot when a water entry signal is detected, wherein the cleaning route planning scheme includes the target heading angle.

Optionally, the underwater robot further includes a cleaning route displaying device configured to display a traveling area of the underwater robot within a target time period, and the control method further includes:
obtaining a deviation value between an actual traveling direction and the traveling area when the actual traveling route of the underwater robot does not match the traveling area displayed on the cleaning route displaying device; and
determining a fourth rotation speed adjustment amount of the travelling motor and/or the water pumping motor according to the deviation value; and
adjusting the rotation speed of the travelling motor and/or the water pumping motor according to the fourth rotation speed adjustment amount.

Optionally, said determining a rotation speed adjustment amount of a travelling motor and/or a water pumping motor according to the deviation angle and adjusting a rotation speed of the travelling motor and/or the water pumping motor according to the rotation speed adjustment amount further includes:
determining an offset direction of the underwater robot according to the deviation angle;
increasing the rotation speed of a wheel corresponding to the travelling motor in a same direction as the offset direction when the rotation speed adjustment amount is positive; and
reducing the rotation speed of the wheel corresponding to the travelling motor in a direction opposite to the offset direction when the rotation speed adjustment amount is negative.

In addition, to achieve the above objective, the present application further provides an underwater robot, which includes a memory, a processor, and a control program that is stored on the non-transitory memory storage and executable on the processor, and when the control program is executed by the processor, the following instructions are implemented:
determining an attitude angle of the underwater robot according to inspection data of an inertial sensor, and determining a heading angle of the underwater robot according to the attitude angle;
determining a deviation angle between the heading angle and a target heading angle;
determining a rotation speed adjustment amount of a travelling motor and/or a water pumping motor according to the deviation angle; and
adjusting a rotation speed of the travelling motor and/or the water pumping motor according to the rotation speed adjustment amount.

In addition, to achieve the above objective, the present application further provides a computer-readable, non-transitory storage medium, in which a control program is stored, and when the control program is executed by a processor, the following instructions are implemented:
determining an attitude angle of the underwater robot according to inspection data of an inertial sensor, and determining a heading angle of the underwater robot according to the attitude angle;
determining a deviation angle between the heading angle and a target heading angle;
determining a rotation speed adjustment amount of a travelling motor and/or a water pumping motor according to the deviation angle; and
adjusting a rotation speed of the travelling motor and/or the water pumping motor according to the rotation speed adjustment amount.

### Beneficial Effects

The embodiments of the present application provide a control method, an underwater robot, and a storage medium. After the underwater robot receives inspection data from an inertial sensor, the current attitude angle of the underwater robot is calculated according to the inspection data, and the heading angle is determined according to the attitude angle; when there is a deviation between the heading angle and the target heading angle, the deviation angle between the heading angle and the target heading angle is determined; subsequently, the rotation speed adjustment amount of the travelling motor and/or the water pumping motor of the underwater robot is determined according to the deviation angle, and the rotation speed of the travelling motor and/or the water pumping motor is adjusted according to the rotation speed adjustment amount. As can be seen, in the operation process of the underwater robot, the current heading angle is continuously calculated through the inertial sensor, and the traveling direction of the underwater robot is continuously corrected according to the deviation of the heading angle, so as to ensure that the underwater robot travels on a given heading, without affecting the pre-planned cleaning route, thereby achieving full-coverage cleaning of a specific area in a swimming pool.

### BRIEF DESCRIPTION OF DRAWINGS

Herein, the figures are incorporated into the description and constitute a part of the description, illustrating embodiments in conformity with the present application and serving together with the description to explain the principle of the present application. To make the technical solution of the embodiments of the present application clearer, a brief introduction will be given below to the figures that need to be used in the illustration of the embodiments. It is obvious that those skilled in the art can obtain other figures according to these figures without creative labor.

FIG. 1 is a flowchart of a first embodiment of a moving direction control method for an underwater robot in the present application;

FIG. 2 is a flowchart of a second embodiment of the control method applied in the underwater robot in the present application;

FIG. 3 is a flowchart of a third embodiment of the control method applied in the underwater robot in the present application;

FIG. 4 is a structure diagram of terminal hardware in the embodiments of the control method applied in the underwater robot in the present application.

With reference to the figures, the realization of the objective, the functional features, and the advantages of the present application will be further explained in combination with the embodiments.

### DESCRIPTION OF EMBODIMENTS

It should be understood that the specific embodiments described herein are only used to explain the present application and are not intended to limit the present application.

In the process of performing a cleaning task, a swimming pool cleaning robot needs to plan a cleaning route to ensure full coverage cleaning of a specific area of the swimming pool. However, when the swimming pool cleaning robot is running, the heading of the swimming pool cleaning robot may change and deviate from the pre-planned route due to external factors such as an uneven pool bottom and an obstacle to be avoided. Route deviation will stop the swimming pool cleaning robot from completing full coverage cleaning of the specific area of the swimming pool.

To eliminate the above defect, the embodiment of the present application proposes a control method applied in an underwater robot, and the main solution includes the following steps:
determining an attitude angle of the underwater robot according to inspection data of an inertial sensor, and determining a heading angle of the underwater robot according to the attitude angle;
determining a deviation angle between the heading angle and a target heading angle of the underwater robot;
determining a rotation speed adjustment amount of a travelling motor and/or a water pumping motor according to the deviation angle; and
adjusting a rotation speed of the travelling motor and/or the water pumping motor according to the rotation speed adjustment amount.

As the present application uses the control method applied in underwater robots, in the operation process of the underwater robot, the current heading angle is continuously calculated through the inertial sensor, and the traveling direction of the underwater robot is continuously corrected according to the deviation of the heading angle, so as to ensure that the underwater robot travels on a given moving direction, without affecting the pre-planned cleaning route, thereby achieving full-coverage cleaning of a specific area in a swimming pool.

For a better understanding of the above technical solution, the exemplary embodiments of the present disclosure will be described in more detail as below with reference to the figures. Although the exemplary embodiments of the present disclosure are shown in the figures, it should be understood that the present disclosure may be implemented in various forms and should not be limited by the embodiments described herein. On the contrary, these embodiments are provided to have a more thorough understanding of the present disclosure and fully communicate the scope of the present disclosure to those skilled in the art.

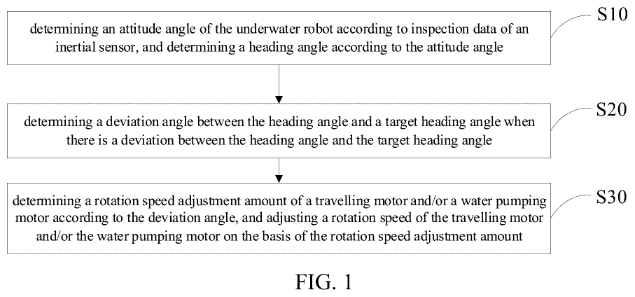

Referring to FIG. 1, FIG. 1 is a flowchart of a first embodiment of the control method applied in the underwater robot in the present application.

In the present embodiment, the control method applied in the underwater robot comprises the following steps S10-S30.

Step S10, determining an attitude angle of the underwater robot according to inspection data of an inertial sensor, and determining a heading angle according to the attitude angle.

Specifically, the underwater robot can be a swimming pool cleaning robot, wherein the swimming pool cleaning robot is equipped with an IMU (Inertial Measurement Unit) sensor, also known as an inertial sensor. The inspection data of the inertial sensor are attitude change values of the underwater robot per second in the cleaning process. The attitude angle is used to describe the orientation and attitude of the underwater robot in space, including heading angle, pitch angle, and roll angle. The driving system of the underwater robot can be a wheeled or tracked one.

When the underwater robot is performing a cleaning task in a swimming pool, external factors such as an uneven pool bottom and an obstacle to be avoided may deviate the underwater robot from a target heading corresponding to the cleaning route, resulting in the failure to complete full coverage cleaning of an area to be cleaned. Therefore, to ensure that the full coverage of the area to be cleaned is clear, a main control chip of the underwater robot continuously reads data from the IMU sensor in the cleaning process to obtain a current attitude angle of the underwater robot, and determines the heading angle of the underwater robot according to the current attitude angle, so that the underwater robot can judge a deviation value between the current heading angle and the target heading angle according to the current heading angle, and further correct the current heading of the underwater robot according to the deviation value. It should be noted that the heading angle of the underwater robot is a relative coordinate, rather than an actual geographic coordinate.

As an example, the inertial sensor comprises a 3-axis gyroscope and a 3-axis accelerometer. The inspection parameters of the inertial sensor comprise gyroscope parameters and acceleration parameters. When the underwater robot performs a cleaning task in a swimming pool, the underwater robot obtains the gyroscope parameters collected by the 3-axis gyroscope and the acceleration parameters collected by the 3-axis accelerometer. Subsequently, the acceleration parameters are converted into unit vectors, and the vector units and the gyroscope parameters are used as input parameters to obtain a quaternion array to calculate the attitude angle of the underwater robot according to the quaternion array. Further, the heading angle of the underwater robot is selected from the attitude angles obtained through calculation.

Before the underwater robot enters water to clean the swimming pool, it is necessary to determine a cleaning route and a target heading angle corresponding to the cleaning route. Therefore, steps before step S10 include steps S40-S50.

Step S40, scanning a swimming pool area with a three-dimensional laser scanner, and dividing the swimming pool area into a plurality of areas according to scanning results of the swimming pool area by the three-dimensional laser scanner, each of the plurality of area being equally sized.

Step S50, generating a cleaning route planning scheme according to the plurality of areas, and executing the cleaning route planning scheme by the underwater robot when a water entry signal is detected, wherein the cleaning route planning scheme includes the target heading angle.

As an example, the underwater robot is equipped with a three-dimensional laser scanner. Before entering the water for cleaning, a user can send a scanning instruction to the underwater robot through a mobile app (application). Subsequently, the underwater robot scans the swimming pool through the three-dimensional laser scanner. To facilitate generating the cleaning route, the underwater robot divides scanning results into a plurality of equal areas and generates a cleaning route planning scheme according to the equal areas, wherein the cleaning route planning scheme is further arranged to have a target heading angle, and the underwater robot will travel according to the target heading angle when performing swimming pool cleaning actions according to the cleaning route.

It should be noted that the user can also send the scanning instruction to the underwater robot in other manners, such as clicking a scanning button, and can also scan the swimming pool through other devices. The above exemplary solutions are only used for explanation, rather than limitations on the present application.

Step S20, determining a deviation angle between the heading angle and a target heading angle when there is a deviation between the heading angle and the target heading angle.

Specifically, in this step, when detecting that the heading angle is different from the target heading angle, the underwater robot can determine that there is a deviation in the current traveling direction of the underwater robot. Based on this, a deviation angle between the current heading angle and the target heading angle can be calculated through a computing chip, so that the underwater robot can adjust the traveling direction according to the deviation angle, thereby ensuring that the underwater robot carries out full coverage cleaning of a specific area.

Optionally, when determining the deviation angle between the heading angle and the target heading angle, it is also necessary to determine an offset direction of the underwater robot, so that the underwater robot can select the travelling motor and/or the water pumping motor in the corresponding direction according to the offset direction.

Step S30, determining a rotation speed adjustment amount of a travelling motor and/or a water pumping motor according to the deviation angle, and adjusting a rotation speed of the travelling motor and/or the water pumping motor according to the rotation speed adjustment amount.

In the present embodiment, both the travelling motor and the water pumping motor can adjust the traveling direction of the underwater robot, the rotation speed adjustment amount may comprise the rotation speed of the travelling motor and/or the pumping power of the water pumping motor, and the higher the rotation speed of the water pumping motor, the higher the pumping power. When the underwater robot carries out cleaning at the pool bottom, the direction of motion of the underwater robot can be adjusted by adjusting the rotation speed of the travelling motor of the underwater robot. When the underwater robot is cleaning the waterline, it is necessary to adjust the pumping power of the water pumping motor of the underwater robot to complete the adjustment of the movement direction of the underwater robot. In the case of cleaning the pool wall, the cleaning direction of the underwater robot can be adjusted by simultaneously adjusting the rotation speed of the travelling motor and the pumping power of the water pumping motor. It should be noted that the specific scenarios as mentioned above and the motor as used are only used for explanation, rather than limitations upon the scope of the present application.

As an example, the target heading angle of the underwater robot is 90 degrees straight ahead. After detecting and crossing an obstacle, the underwater robot detects a subsequent heading angle of 75 degrees (i.e., 15 degrees to the right). At this moment, the underwater robot increases the rotation speed of a right travelling motor, shifts the traveling direction of the underwater robot to the left, and gradually approaches the target heading angle.

Optionally, the offset direction of the underwater robot can also be determined through the deviation angle, and when the rotation speed adjustment amount is positive, i.e., the rotation speed needs to be increased, the rotation speed of a wheel corresponding to the travelling motor opposite to the offset direction can be increased to make the underwater robot move in the direction opposite to the offset. If the adjustment amount is negative, the opposite speed of a wheel corresponding to the travelling motor in the direction opposite to the offset can be reduced.

In the technical solution disclosed in the present embodiment, when the underwater robot carries out cleaning, the gyroscope parameters and the acceleration parameters are obtained through the 3-axis gyroscope and the 3-axis acceleration in the inertial sensor; the attitude angle of the underwater robot is calculated according to the gyroscope parameters and the acceleration parameters; further, the heading angle of the underwater robot is determined; moreover, when a deviation is detected between the heading angle and the target heading angle, the deviation angle between the heading angle and the target heading angle is calculated; according to the deviation angle, the rotation speed adjustment amount of the travelling motor and/or the water pumping motor is determined; furthermore, the rotation speed of the travelling motor and/or the water pumping motor is adjusted according to the rotation speed adjustment amount; further, the traveling direction of the underwater robot is continuously corrected, so that the underwater robot can travel on the planned heading, thereby realizing full coverage cleaning of a specific area in a swimming pool.

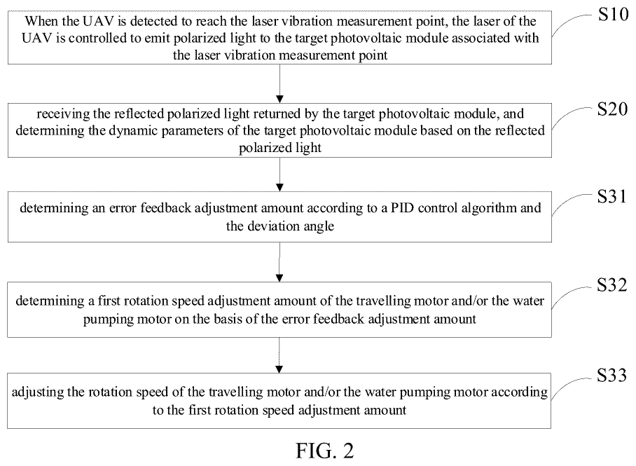

Referring to FIG. 2, in a second embodiment, according to the first embodiment, step S30 further comprises steps S31-S32.

Step S31, determining adjustment amount of an error feedback according to a PID control algorithm and the deviation angle.

In the present embodiment, the PID (proportion, integration, differentiation) control algorithm is a control algorithm that combines proportion, integration, and differentiation. By adjusting the proportion of the rotation speed, the traveling direction of the underwater robot is made to approach the preset traveling direction; subsequently, error analysis of the deviation value of the adjusted underwater robot is carried out, and error results are subjected to integral accumulation; further, after the rotation speed adjustment amount is output according to integral results to bring the underwater robot back to the preset traveling direction, the traveling trajectory tends to be stable; finally, through differential control, the variation trend of the deviation angle of the underwater robot from the deviation to the stable state is subjected to differential adjustment, so as to obtain the rotation speed adjustment amount for future time periods, thereby ensuring the stability of the cleaning of the underwater robot.

The adjustment amount of the error feedback refers to the control amount obtained through proportional control of the PID control algorithm configured to determine the rotation speed adjustment amount of the travelling motor and/or the water pumping motor of the underwater robot after the deviation occurs. After obtaining the deviation angle of the underwater robot, the adjustment amount of the error feedback can be determined through the proportional adjustment of the PID control algorithm, so that the underwater robot can calculate a first rotation speed adjustment amount according to the error feedback adjustment amount.

As an example, when the deviation angle between the heading angle and the target heading angle is 15 degrees and the deviation direction is on the left, the adjustment amount of the error feedback (i.e., the rotation speed adjustment proportion) of the underwater robot is determined to be 50% through the proportional adjustment in the PID control algorithm.

Step S32, determining a first rotation speed adjustment amount of the travelling motor and/or the water pumping motor according to the error feedback adjustment amount.

Specifically, after determining the error feedback adjustment amount, the first rotation speed adjustment amount can be determined according to the error feedback adjustment amount. For example, when the adjustment amount of the error feedback is 50%, i.e., increasing the rotation speed by 50%, the travelling motor of the underwater robot has a rotation speed of 20 r/min, and needs to be adjusted by 10 r/min; thus, it is obtained according to the adjustment amount of the error feedback that the first rotation speed adjustment amount is 10 r/min.

Step S33, adjusting the rotation speed of the travelling motor and/or the water pumping motor according to the first rotation speed adjustment amount.

In a specific scenario, the first rotation speed adjustment amount determined by the proportional adjustment of the PID control algorithm is 10 r/min, and the offset direction is on the left; at this moment, the rotation speed adjustment of the left travelling motor of the underwater robot can be carried out, and the underwater robot can increase the rotation speed of the left travelling motor by 10 r/min through the main control chip, so that the target direction of the underwater robot can quickly deflect to the right. The principle of adjusting the rotation speed of the water pumping motor is the same, and will not be further elaborated herein.

It can be understood that after the underwater robot carries out the adjustment, when the traveling direction of the underwater robot approaches the preset traveling direction, i.e., the deviation between the heading angle and the target heading angle is relatively small, the rotation speed of the adjusted travelling motor and/or water pumping motor of the underwater robot is adjusted back to the original rotation speed, so that the underwater robot can maintain the current traveling direction.

It should be noted that the specific implementation parameters need to be set according to actual needs, and the above parameters are only used for explanation, rather than limitations upon the scope of the present application.

Further, the proportional adjustment is the adjustment of the travelling motor and/or the water pumping motor of the underwater robot, and mainly serves to make the traveling direction of the underwater robot approach the preset traveling direction. Therefore, after adjusting the rotation speed of the travelling motor and/or the water pumping motor of the underwater robot through the first rotation speed adjustment amount, the traveling direction of the underwater robot may always deviate slightly from the preset direction, i.e., there may exist error data, so as to affect the full coverage cleaning of a specific area. As such, after the proportional adjustment, when the traveling direction of the underwater robot gradually approaches the preset traveling direction, the integral control adjustment in the PID control algorithm can continue to adjust the rotation speed of the underwater robot. In other words, steps after step S33 further comprise steps S34-S36.

Step S34, determining an error angle of the underwater robot after adjustment through the first rotation speed adjustment amount.

Specifically, the error angle refers to the change error of the deviation angle of the underwater robot from the detection that the current deviation occurs to the adjustment of the rotation speed of the travelling motor and/or the water pumping motor through the first rotation speed adjustment amount. For example, when it is detected that a deviation occurs in the underwater robot, the deviation angle is 15 degrees; subsequently, after the adjustment by the first rotation speed adjustment amount, the deviation angle may vary between 0 and 2 degrees, and the change value at this stage is the error angle. At this moment, it is necessary to integrate changes in the error angle through the integral control of the PID control algorithm, and further determine the second rotation speed adjustment amount according to the integrated value, thereby making the cleaning route of the underwater robot more stable.

Step S35, determining an integral control amount according to the PID control algorithm and the error angle, and determining a second rotation speed adjustment amount of the travelling motor and/or the water pumping motor according to the integral control amount;

Specifically, after the proportional adjustment of the travelling motor and/or the water pumping motor of the underwater robot, there is still an error between the adjusted traveling direction of the underwater robot and the preset direction; at this moment, the error angle can be multiplied by the integral constant, and the integral value can be obtained; further, the second rotation speed adjustment amount of the travelling motor and/or the water pumping motor can be calculated according to the integral data, so that the underwater robot can make a second rotation speed adjustment of the travelling motor and/or the water pumping motor according to the second rotation speed adjustment amount, thereby making the traveling state of the underwater cleaning robot tend to be stable during cleaning.

step S36, adjusting the rotation speed of the travelling motor and/or the water pumping motor of the underwater robot according to the second rotation speed adjustment amount.

After obtaining the second rotation speed adjustment amount and the motor that needs to be adjusted, the rotation speed of the corresponding motor is adjusted according to the second rotation speed adjustment amount, to ensure that the error angle subsequently detected by the underwater robot approaches zero, i.e., the currently detected heading angle is the target heading angle.

It should be noted that the specific implementation parameters need to be set according to actual needs, and the above parameters are only used for explanation, rather than limitations upon the scope of the present application.

Further, after the integral adjustment, the traveling direction of the underwater robot tends to be stable; at this moment, to avoid the underwater robot from subsequent emergency situations, changes in the deviation angle in the future can be predicted through the differential control of the PID control algorithm; further, the rotation speed of the underwater robot is regulated in advance. In other words, steps after step S36 further comprise steps S37-S39.

Step S37, obtaining historical change values of the deviation angle;

In the present embodiment, the historical change values of the deviation angle are change values of the deviation angle of the underwater robot from the execution of the proportional adjustment to the integral control.

Step S38, determining a variation trend of the deviation angle according to the PID control algorithm and the historical change values, and determining a third rotation speed adjustment amount of the travelling motor and/or the water pumping motor according to the variation trend of the deviation angle;

Specifically, the variation trend of the deviation angle can be obtained by differentiating the historical change values through the PID control algorithm; further, the variation trend of the traveling trajectory of the underwater robot within the preset time period can be obtained according to the variation trend, and the third rotation speed adjustment amount can be generated according to the variation trend. For example, it is determined through the differential control that the variation trend of the underwater robot in the next 5 seconds is to shift to the right by 2 degrees; therefore, the rotation speed of a right travelling motor of the underwater robot can be increased in advance, so as to ensure that the underwater robot can clean smoothly in the direction of the target heading angle according to the variation trend when performing a cleaning task in the future.

Step S39, adjusting the rotation speed of the travelling motor and/or the water pumping motor of the underwater robot according to the third rotation speed adjustment amount.

Through the differential control of the PID control algorithm, the third rotation speed adjustment amount in the future time period can be further obtained; further, the rotation speed can be adjusted according to the third rotation speed adjustment amount, so as to ensure the heading of the underwater robot, thereby accurately completing full coverage cleaning of the swimming pool area.

It should be noted that the specific implementation parameters need to be set according to actual needs, and the above parameters are only used for explanation, rather than limitations upon the scope of the present application.

In the technical solution disclosed in the present embodiment, the deviation angle of the underwater robot is calculated through the proportional adjustment, integral control, and differential control; further, multiple rotation speed adjustments of the travelling motor and/or the water pumping motor are completed, so that the underwater robot can accurately follow the route corresponding to the cleaning route planning scheme, thereby ensuring full coverage cleaning of a specific area in a swimming pool.

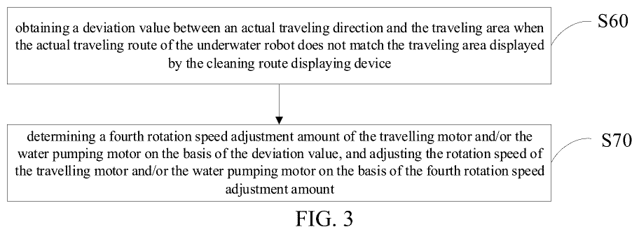

Referring to FIG. 3, in a third embodiment, the underwater robot further includes a cleaning route displaying device configured to display a traveling area of the underwater robot within a target time period, and the control method applied in the underwater robot further comprises steps S60-S70.

Step S60, obtaining a deviation value between an actual traveling direction and the traveling area when the actual traveling route of the underwater robot does not match the traveling area displayed on the cleaning route displaying device;

In the present embodiment, the cleaning route display device can display a preset cleaning route; if the actual route of the underwater robot does not match the area corresponding to the cleaning route, it indicates a deviation in the traveling direction of the underwater robot; at this moment, the deviation value between the actual traveling direction and the traveling area can be obtained, so that the underwater robot can adjust the traveling direction according to the deviation value.

Step S70, determining a fourth rotation speed adjustment amount of the travelling motor and/or the water pumping motor according to the deviation value, and adjusting the rotation speed of the travelling motor and/or the water pumping motor according to the fourth rotation speed adjustment amount.

In the present embodiment, the fourth rotation speed adjustment amount of the travelling motor and/or the water pumping motor can be calculated through the PID algorithm according to the deviation value, and the rotation speed of the travelling motor and/or the water pumping motor can be adjusted according to the fourth rotation speed adjustment amount.

In the technical solution disclosed in the present embodiment, the traveling direction of the underwater robot is detected through a cleaning display device, so as to obtain the deviation value of the underwater robot during travel, so that the underwater robot can determine whether there is a deviation in the current traveling direction through the cleaning display device, thereby ensuring that the underwater robot can travel in the preset traveling direction, and further completing full coverage cleaning of a specific area.

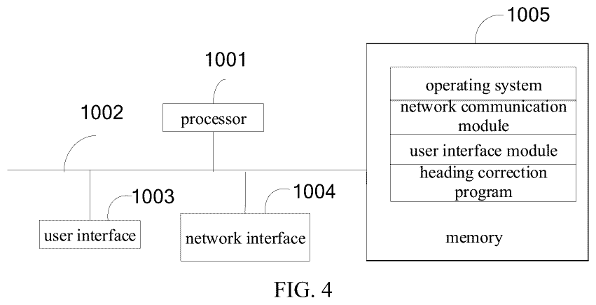

Referring to FIG. 4, FIG. 4 is a structure diagram of a terminal in a hardware operating environment involved in the solutions of the embodiments in the present application.

As shown in FIG. 4, the terminal may comprise: a processor 1001, such as CPU, a network interface 1004, a user interface 1003, a memory 1005, and a communication bus 1002. Wherein, the communication bus 1002 is used to realize connection communication between these components. The user interface 1003 may comprise a display, an input unit such as a keyboard. Optionally, the user interfaces 1003 may also comprise standard wired and wireless interfaces. The optional network interface 1004 can comprise standard wired and wireless interfaces (such as WI-FI interfaces). The memory 1005 can be a high-speed RAM memory or a non-volatile memory, such as a disk memory. Optionally, the memory 1005 can also be a storage device independent of the aforementioned processor 1001.

Those skilled in the art can understand that the terminal structure shown in FIG. 4 does not constitute a limitation on the terminal, and may comprise more or fewer components than shown in the diagram, combine certain components, or arrange different components.

As shown in FIG. 4, the memory 1005 as a computer storage medium may comprise an operating system, a data storage module, a network communication module, and a control program.

In the terminal shown in FIG. 4, the network interface 1004 is mainly used for connection with a backend server and data communication with the backend server; the processor 1001 can call the control program stored in the memory 1005, and perform the following operations:
determining an attitude angle of the underwater robot according to inspection data of an inertial sensor, and determining a heading angle according to the attitude angle;
determining a deviation angle between the heading angle and a target heading angle when there is a deviation between the heading angle and the target heading angle; and
determining a rotation speed adjustment amount of a travelling motor and/or a water pumping motor according to the deviation angle, and adjusting a rotation speed of the travelling motor and/or the water pumping motor according to the rotation speed adjustment amount.

Further, the processor 1001 can call the control program stored in the memory 1005, and perform the following operations:
determining adjustment amount of an error feedback according to a PID control algorithm and the deviation angle;
determining a first rotation speed adjustment amount of the travelling motor and/or the water pumping motor according to the error feedback adjustment amount; and
adjusting the rotation speed of the travelling motor and/or the water pumping motor according to the first rotation speed adjustment amount.

Further, the processor 1001 can call the control program stored in the memory 1005, and perform the following operations:
determining an error angle of the underwater robot after adjustment through the first rotation speed adjustment amount;
determining an integral control amount according to the PID control algorithm and the error angle, and determining a second rotation speed adjustment amount of the travelling motor and/or the water pumping motor according to the integral control amount; and
adjusting the rotation speed of the travelling motor and/or the water pumping motor of the underwater robot according to the second rotation speed adjustment amount.

Further, the processor 1001 can call the control program stored in the memory 1005, and perform the following operations:
obtaining historical change values of the deviation angle;
determining a variation trend of the deviation angle according to the PID control algorithm and the historical change values, and determining a third rotation speed adjustment amount of the travelling motor and/or the water pumping motor according to the variation trend of the deviation angle; and
adjusting the rotation speed of the travelling motor and/or the water pumping motor of the underwater robot according to the third rotation speed adjustment amount.

Further, the processor 1001 can call the control program stored in the memory 1005, and perform the following operations:
obtaining the gyroscope parameters collected by the 3-axis gyroscope and the acceleration parameters collected by the 3-axis accelerometer.

Said determining an attitude angle of the underwater robot according to inspection data of an inertial sensor and determining a heading angle according to the attitude angle comprises:
converting the acceleration parameters into unit vectors, and applying the vector units and the gyroscope parameters as input parameters to obtain a quaternion array; and
calculating the attitude angle of the underwater robot according to the quaternion array, wherein the attitude angle further comprises a roll angle and a pitch angle.

Further, the processor 1001 can call the control program stored in the memory 1005, and perform the following operations:
scanning a swimming pool area with a three-dimensional laser scanner, and dividing the swimming pool area into a plurality of areas according to scanning results of the swimming pool area by the three-dimensional laser scanner, each of the plurality of area being equally sized; and
generating a cleaning route planning scheme according to the plurality of areas, and executing the cleaning route planning scheme by the underwater robot when a water entry signal is detected, wherein the cleaning route planning scheme includes the target heading angle.

Further, the processor 1001 can call the control program stored in the memory 1005, and perform the following operations:
obtaining a deviation value between an actual traveling direction and the traveling area when the actual traveling route of the underwater robot does not match the traveling area displayed on the cleaning route displaying device; and
determining a fourth rotation speed adjustment amount of the travelling motor and/or the water pumping motor according to the deviation value, and adjusting the rotation speed of the travelling motor and/or the water pumping motor according to the fourth rotation speed adjustment amount.

Further, the processor 1001 can call the control program stored in the memory 1005, and perform the following operations:
determining an offset direction of the underwater robot according to the deviation angle;
increasing the rotation speed of a wheel corresponding to the travelling motor in the same direction as the offset direction when the rotation speed adjustment amount is positive; and
reducing the rotation speed of a wheel corresponding to the travelling motor in the opposite direction to the offset direction when the rotation speed adjustment amount is negative.

In addition, those skilled in the art can understand that all or some of the procedures in the method of the above embodiments can be accomplished by relevant hardware under the instruction of a computer program. The computer program comprises a program instruction, and can be stored in a storage medium, which is a computer-readable storage medium. The program instruction is executed by at least one processor in the control terminal to implement the steps in the embodiments of the above method.

Therefore, the present application further provides a computer-readable storage medium, in which a control program is stored, and each step in the control method applied in an underwater robot as described in the above embodiments is implemented when the control program is executed by a processor.

It should be noted that since the storage medium provided in the embodiments of the present application is the storage medium used to implement the method in the embodiments of the present application, those skilled in the art can understand the specific structure and transformation of the storage medium according to the method introduced in the embodiments of the present application, and neither will be repeated herein. All storage media used in the method in the embodiments of the present application fall within the scope of protection of the present application.

Those skilled in the art should understand that the embodiments of the present application can be provided as a method, a system, or a computer program product. Therefore, the present application can adopt the form of a pure hardware embodiment, a pure software embodiment, or an embodiment that combines software with hardware. Moreover, the present application can take the form of a computer program product implemented on one or more computer-usable storage media (including but not limited to a disk memory, CD-ROM, an optical memory, etc.) containing computer-usable program codes.

The present application is described referring to the flowchart and/or block diagram of the method, the device (system), and the computer program product according to the embodiments of the present application. It should be understood that each procedure and/or block in the flowchart and/or block diagram, as well as a combination of procedures and/or blocks in the flowchart and/or block diagram, can be implemented by computer program instructions. These computer program instructions can be provided to a processor of a general-purpose computer, a specialized computer, an embedded processor, or other programmable data processing devices to generate a machine, so that the instructions executed by the processor of the computer or other programmable data processing devices generate a device for implementing the functions specified in one or more procedures in the flowchart and/or one or more boxes in the block diagram.

These computer program instructions can also be stored in a computer-readable memory that can guide a computer or other programmable data processing devices to operate in a specific manner, so that the instructions stored in the computer-readable memory produces a manufactured product comprising an instruction device, which implements the functions specified in one or more procedures in the flowchart and/or one or more boxes in the block diagram.

These computer program instructions can also be loaded onto a computer or other programmable data processing devices, so that a series of operational steps are executed on the computer or other programmable devices to generate the processing implemented by the computer. In this way, the instructions executed on the computer or other programmable devices provide steps for implementing the functions specified in one or more procedures in the flowchart and/or one or more boxes in the block diagram.

It should be noted that any reference signs located between brackets in the claims should not be constructed as limitations on the claims. The word “comprising” does not exclude the existence of components or steps that are not listed in the claims. The word “one” before a component does not exclude the existence of multiple components of the same kind. The present application can be implemented by means of hardware comprising a plurality of different components and by means of an appropriately programmed computer. In the unit claims that list a plurality of devices, several of these devices can be specifically embodied through a single hardware item. The use of words such as first, second, and third does not indicate any order. These words can be interpreted as names.

Although the preferred embodiments of the present application have been described, those skilled in the art can make additional changes and modifications to these embodiments once they are aware of the basic inventive concepts. Therefore, the attached claims are intended to be interpreted as including the preferred embodiments as well as all changes and modifications that fall within the scope of the present application.

Obviously, those skilled in the art can make various changes and transformations to the present application without departing from the spirit and scope of the present application. In this way, if these modifications and transformations of the present application fall within the scope of the claims and equivalent technologies of the present application, then the present application also intends to include these modifications and transformations.

The above content only relates to the preferred embodiments of the present application, and does not limit the patent scope of the present application. Any change for the equivalent structure or equivalent flow that is made by using the content of the description and drawings in the present application, directly or indirectly applied in other related technical fields, also falls within the scope of patent protection of the present application.

1. A control method applied in an underwater robot, comprising:
determining an attitude angle of the underwater robot according to inspection data of an inertial sensor, and determining a heading angle of the underwater robot according to the attitude angle;
determining a deviation angle between the heading angle and a target heading angle of the underwater robot;
determining a rotation speed adjustment amount of a travelling motor and/or a water pumping motor according to the deviation angle; and
adjusting a rotation speed of the travelling motor and/or the water pumping motor according to the rotation speed adjustment amount.

2. The control method applied in of claim 1, wherein said determining a rotation speed adjustment amount of the travelling motor and/or the water pumping motor according to the deviation angle and adjusting the rotation speed of the travelling motor and/or the water pumping motor according to the rotation speed adjustment amount further comprises:
determining an adjustment amount of an error feedback according to a proportion, integration, differentiation (PID) control algorithm and the deviation angle;
further determining a first rotation speed adjustment amount of the travelling motor and/or the water pumping motor according to the adjustment amount of the error feedback adjusting the rotation speed of the travelling motor and/or the water pumping motor according to the first rotation speed adjustment amount.

3. The control method applied in of claim 2, wherein after said adjusting the rotation speed of the travelling motor and/or the water pumping motor according to the first rotation speed adjustment amount, the control method further comprises:
determining an error angle of the underwater robot;
determining an integral control amount according to the PID control algorithm and the error angle, and determining a second rotation speed adjustment amount of the travelling motor and/or the water pumping motor according to the integral control amount; and
adjusting the rotation speed of the travelling motor and/or the water pumping motor of the underwater robot according to the second rotation speed adjustment amount.

4. The control method applied in of claim 3, wherein after said adjusting the rotation speed of the travelling motor and/or the water pumping motor of the underwater robot according to the second rotation speed adjustment amount, the control method further comprises:
obtaining historical change values of the deviation angle;
determining a trend of the deviation angle according to the PID control algorithm and the historical change values, and determining a third rotation speed adjustment amount of the travelling motor and/or the water pumping motor according to the trend of the deviation angle; and
adjusting the rotation speed of the travelling motor and/or the water pumping motor of the underwater robot according to the third rotation speed adjustment amount.

5. The control method applied in of claim 1, wherein the inertial sensor comprises a 3-axis gyroscope and a 3-axis accelerometer, the inspection data of the inertial sensor comprises gyroscope parameters and acceleration parameters, and before said determining an attitude angle of the underwater robot according to inspection data of an inertial sensor, and determining a heading angle of the underwater robot according to the attitude angle, the control method further comprises:
obtaining the gyroscope parameters collected by the 3-axis gyroscope and the acceleration parameters collected by the 3-axis accelerometer;
said determining an attitude angle of the underwater robot according to inspection data of an inertial sensor and determining a heading angle of the underwater robot according to the attitude angle comprises:
converting the acceleration parameters into unit vectors, and applying the vector units and the gyroscope parameters as input parameters to obtain a quaternion array; and
calculating the attitude angle of the underwater robot according to the quaternion array, the attitude angle comprising a roll angle and a pitch angle.

6. The control method applied in of claim 1, wherein the underwater robot is further equipped with a three-dimensional laser scanner, and before said determining an attitude angle of the underwater robot according to inspection data of an inertial sensor and determining a heading angle of the underwater robot according to the attitude angle further comprises:
scanning a swimming pool area with a three-dimensional laser scanner, and dividing the swimming pool area into a plurality of areas according to scanning results of the swimming pool area by the three-dimensional laser scanner, each of the plurality of area being equally sized; and
generating a cleaning route planning scheme according to the plurality of areas, and executing the cleaning route planning scheme by the underwater robot when a water entry signal is detected, wherein the cleaning route planning scheme comprises the target heading angle.

7. The control method applied in an underwater robot of claim 1, wherein the underwater robot further comprises a cleaning route displaying device configured to display a traveling area of the underwater robot within a target time period, and the control method further comprises:
obtaining a deviation value between an actual traveling direction and the traveling area when the actual traveling route of the underwater robot does not match the traveling area displayed on the cleaning route displaying device; and
determining a fourth rotation speed adjustment amount of the travelling motor and/or the water pumping motor according to the deviation value; and
adjusting the rotation speed of the travelling motor and/or the water pumping motor according to the fourth rotation speed adjustment amount.

8. The control method applied in an underwater robot of claims 1, wherein said determining a rotation speed adjustment amount of a travelling motor and/or a water pumping motor according to the deviation angle and adjusting a rotation speed of the travelling motor and/or the water pumping motor according to the rotation speed adjustment amount further comprises:
determining an offset direction of the underwater robot according to the deviation angle;
increasing the rotation speed of a wheel corresponding to the travelling motor in a same direction as the offset direction when the rotation speed adjustment amount is positive; and
reducing the rotation speed of the wheel corresponding to the travelling motor in an direction opposite to the offset direction when the rotation speed adjustment amount is negative.

9. An underwater robot comprising a non-transitory memory storage, a processor, and a control program that is stored on the non-transitory memory storage and executable on the processor, and when the control program is executed by the processor, the following instructions are implemented:
determining an attitude angle of the underwater robot according to inspection data of an inertial sensor, and determining a heading angle of the underwater robot according to the attitude angle;
determining a deviation angle between the heading angle and a target heading angle;
determining a rotation speed adjustment amount of a travelling motor and/or a water pumping motor according to the deviation angle; and
adjusting a rotation speed of the travelling motor and/or the water pumping motor according to the rotation speed adjustment amount.

10. A computer-readable, non-transitory storage medium, wherein a control program is stored in the computer-readable, non-transitory storage medium, and when the control program is executed by a processor, the following instructions are implemented:
determining an attitude angle of the underwater robot according to inspection data of an inertial sensor, and determining a heading angle of the underwater robot according to the attitude angle;
determining a deviation angle between the heading angle and a target heading angle;
determining a rotation speed adjustment amount of a travelling motor and/or a water pumping motor according to the deviation angle; and
adjusting a rotation speed of the travelling motor and/or the water pumping motor according to the rotation speed adjustment amount.
